(19) United States
(12) Patent Application Publication
(10) Pub. No.: US 2026/0311700 A1
(43) Pub. Date: Oct. 8, 2026

(54) LANGUAGE-ENABLED INTELLIGENCE SYSTEM FOR AIRCRAFT INTERIORS

(71) Applicant: B/E Aerospace, Inc., Winston-Salem, NC (US)

(72) Inventors: Soumalya Sarkar, Glastonbury, CT (US); Andrew Radlbeck, South Glastonbury, CT (US); Zhuolin Jiang, Newton Center, MA (US); Brian E. St. Rock, Andover, CT (US)

(73) Assignee: B/E Aerospace, Inc., Winston-Salem, NC (US)

(21) Appl. No.: 19/633,515

(22) Filed: Mar. 30, 2026

Related U.S. Application Data
(60) Provisional application No. 63/783,577, filed on Apr. 4, 2025.

(51) Int. Cl. G10L 15/22; B64D 11/00; B64D 11/04; G06F 3/16; G10L 13/02; G10L 15/18

(52) U.S. Cl. CPC G10L 15/22; B64D 11/0007; B64D 11/0015; B64D 11/04; G06F 3/167; G10L 13/02; G10L 15/1815; G10L 2015/225

(57) ABSTRACT

A language-enabled intelligence system for aircraft interiors includes a user interface and a controller. The user interface is configured to receive and transmit information. The user interface includes an automatic speech recognition (ASR) mechanism configured to interpret information received via the user interface and generate interpreted words in text form, and a text to speech (TTS) mechanism configured to create voice narrations from text provided to the TTS mechanism. The controller is configured to classify and filter the interpreted words based on context or intent derived from the set of interpreted words; and generate a response, wherein the response is the text that is transmitted to the user interface and relayed via the TTS mechanism.

### CROSS-REFERENCE TO RELATED APPLICATIONS

This application claims priority to and the benefit of, U.S. Provisional Application No. 63/783,577, filed Apr. 4, 2025, and entitled “LANGUAGE-ENABLED ARTIFICIAL INTELLIGENCE SYSTEM FOR AIRCRAFT INTERIORS,” which is incorporated by reference herein in its entirety for all purposes.

### FIELD

The present disclosure generally relates to aircraft interiors, and more specifically, to a language-enabled intelligence system for aircraft interiors.

### BACKGROUND

Typically, crew members onboard an aircraft may be assisted by an intelligent system that may monitor aircraft interiors, track inventories, and assist crew members in managing interior operations. This information is typically available in specialized applications for the crew members where they may have a tablet or personal computer to get information and may be cumbersome and time-consuming to use in an operational environment.

### SUMMARY

A language-enabled intelligence system for aircraft interiors is disclosed herein. The system includes a user interface configured to receive and transmit information to a user and a controller. The user interface includes an automatic speech recognition (ASR) mechanism configured to interpret the information received via the user interface and generate a set of interpreted words in text form and a text to speech (TTS) mechanism configured to create voice narrations from text provided to the TTS mechanism. The controller is configured to classify and filter the set of interpreted words based on at least one of context or intent derived from the set of interpreted words. and generate a response. The response is the text that is transmitted to the user interface and relayed to the user via the TTS mechanism.

In various embodiments, the controller is configured to further utilize a status of at least one of items or interior features from a galley to generate the response.

In various embodiments, the status of the at least one of the items or the interior features from the galley is stored in a galley state/item database.

In various embodiments, the controller is further configured to update the status of the at least one of the items or the interior features using temporal filtering and persistent tracking.

In various embodiments, the temporal filtering and persistent tracking is performed using data from at least one sensor, wherein the at least one sensor comprises at least one of an optical sensor, a thermal sensor, an infrared sensor, a near-infrared sensor, a mid-infrared sensor, a far-infrared sensor, an ultraviolet sensor, an ultrasonic sensor, a pressure sensor, a weight sensor, a proximity sensor, a capacitive sensor, an inductive sensor, a piezoelectric sensor, an image sensor, a time-of-flight sensor, a depth sensor, a three-dimensional (3D) sensor, a light detection and ranging (LIDAR) sensor, a radio detection and ranging (RADAR) sensor, a multispectral sensor, a hyperspectral sensor, a radio frequency sensor, an electromagnetic sensor, an acoustic sensor, a vibration sensor, a chemical sensor, a gas sensor, a humidity sensor, a temperature sensor, a motion sensor, an accelerometer, a gyroscope, a magnetometer, an RFID sensor, an NFC sensor, or any combination thereof.

In various embodiments, the controller is further configured to update the status of the at least one of the items or the interior features using verbal feedback received via the ASR mechanism and processed via the controller.

In various embodiments, the controller is further configured to communicate instructions to a crew member, via the user interface, to prepare a galley for taxi, take-off, and/or landing (TTOL).

In various embodiments, the controller is further configured to, responsive to generating the response via the user interface, illuminate at least one of a bin or an insert in a galley or activate an indicator associated with the bin or the insert.

In various embodiments, wherein the user interface is at least one of an infotainment system associated with a passenger seat of the aircraft or a digital panel associated with a galley on the aircraft.

In various embodiments, the response transmitted to the user interface is displayed to the user via the at least one of the infotainment system associated with the passenger seat of the aircraft or the digital panel located in the galley on the aircraft.

Also disclosed herein is an aircraft. The aircraft includes a passenger seat, an infotainment system associated with the passenger seat, a galley, a digital panel associated with the galley, and a language-enabled intelligence system coupled to at least one infotainment system or the digital panel. The language-enabled intelligence system includes a user interface configured to receive and transmit information to a user and a controller. The user interface includes an automatic speech recognition (ASR) mechanism configured to interpret the information received via the user interface and generate a set of interpreted words in text form and a text to speech (TTS) mechanism configured to create voice narrations from text provided to the TTS mechanism. The controller is configured to classify and filter the set of interpreted words based on at least one of context or intent derived from the set of interpreted words and generate a response. The response is the text that is transmitted to the user interface and relayed to the user via the TTS mechanism.

In various embodiments, the controller is configured to further utilize a status of at least one of items or interior features from a galley to generate the response.

In various embodiments, the status of the at least one of the items or the interior features from the galley is stored in a galley state/item database.

In various embodiments, the controller is further configured to update the status of the at least one of the items or the interior features using temporal filtering and persistent tracking.

In various embodiments, the temporal filtering and persistent tracking is performed using data from at least one sensor, wherein the at least one sensor comprises at least one of an optical sensor, a thermal sensor, an infrared sensor, a near-infrared sensor, a mid-infrared sensor, a far-infrared sensor, an ultraviolet sensor, an ultrasonic sensor, a pressure sensor, a weight sensor, a proximity sensor, a capacitive sensor, an inductive sensor, a piezoelectric sensor, an image sensor, a time-of-flight sensor, a depth sensor, a three-dimensional (3D) sensor, a light detection and ranging (LIDAR) sensor, a radio detection and ranging (RADAR) sensor, a multispectral sensor, a hyperspectral sensor, a radio frequency sensor, an electromagnetic sensor, an acoustic sensor, a vibration sensor, a chemical sensor, a gas sensor, a humidity sensor, a temperature sensor, a motion sensor, an accelerometer, a gyroscope, a magnetometer, an RFID sensor, an NFC sensor, or any combination thereof, or any subsequently developed sensor technology capable of detecting environmental conditions, object states, or physical parameters.

In various embodiments, the controller is further configured to update the status of the at least one of the items or the interior features using verbal feedback received via the ASR mechanism and processed via the controller.

In various embodiments, the controller is further configured to communicate instructions to a crew member, via the user interface, to prepare a galley for taxi, take-off, and/or landing (TTOL).

In various embodiments, the controller is further configured to, responsive to generating the response via the user interface, illuminate at least one of a bin or an insert in a galley or activate an indicator associated with the bin or the insert.

In various embodiments, the response transmitted to the user interface is displayed to the user via the infotainment system associated with the passenger seat of the aircraft.

In various embodiments, the response transmitted to the user interface is displayed to the user via the digital panel located in the galley on the aircraft.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft and various sections within the aircraft, in accordance with various embodiments.

FIG. 2 illustrates a layout of a typical larger-bodied passenger aircraft, in accordance with various embodiments.

FIG. 3 illustrates a language-enabled intelligence system, in accordance with various embodiments.

FIG. 4 illustrates a galley of an aircraft, in accordance with various embodiments.

FIG. 5 illustrates a view from a camera configured to provide a streaming view of a galley, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Typically, intelligent systems provide crew members onboard aircrafts the ability to monitor aircraft interiors, to track inventories, and to manage interior operations. However, such intelligent systems require the use of a tablet or personal computer to obtain the information from the intelligent system, which may be cumbersome and time-consuming to use in an operational environment, such as in a galley of an aircraft. Accordingly, in accordance with various embodiments, in order to reduce the need for crew members to use a tablet or personal computer, the illustrative embodiments provide an intelligent system that provides a user interface that crew members and/or passengers may seamlessly interact with to monitor the aircraft interiors (e.g., galley) and assist crew members in tracking and controlling interior functionalities via natural language and speech.

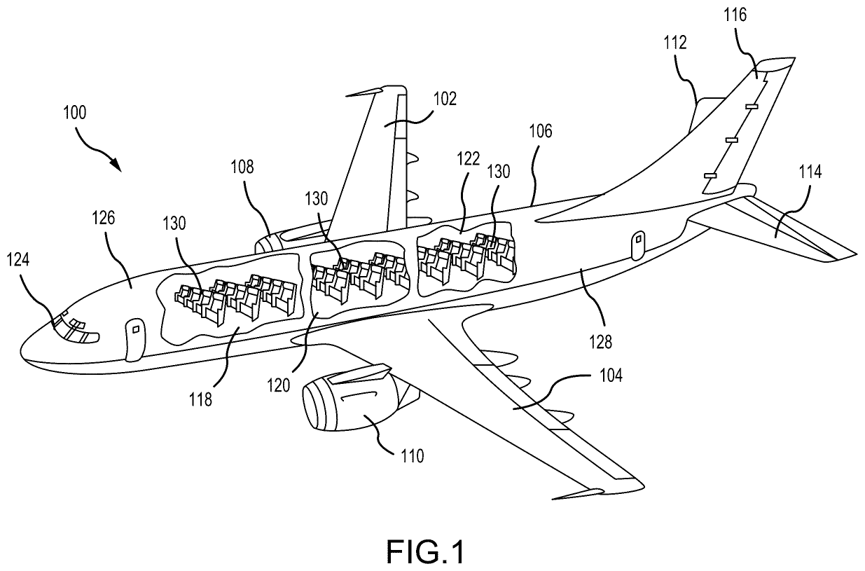

Referring now to FIG. 1, an aircraft 100 and various sections within the aircraft is illustrated, in accordance with various embodiments. Aircraft 100 is an example of a passenger or transport vehicle in which a galley insert status detection system may be implemented in accordance with various embodiments. In various embodiments, aircraft 100 has a starboard wing 102 and a port wing 104 attached to a fuselage 106. In various embodiments, aircraft 100 also includes a starboard engine 108 connected to starboard wing 102 and a port engine 110 connected to port wing 104. In various embodiments, aircraft 100 also includes a starboard horizontal stabilizer 112, a port horizontal stabilizer 114, and a vertical stabilizer 116. In various embodiments, aircraft 100 also includes various cabin sections, including, for example, a first cabin section 118, a second cabin section 120, a third cabin section 122, and a pilot cabin 124. In various embodiments, each of the first cabin section 118, the second cabin section 120, the third cabin section 122 includes passenger seats 130 in which passengers may be seated and each passenger seat includes an associated infotainment system with which interaction with a passenger may occur. In that regard, in various embodiments, each of the one or more infotainment system provide a user interface (UI) for the passengers to interface with a language-enabled intelligence system, so as to perform various operations, i.e., submit requests to crew members or request one or more videos, request operations associated with their seat, i.e. light on/off, air on/off, or seat recline/straighten, among others, in real-time to provide automatic predictive crew service triggers. In various embodiments, aircraft 100 may include at least a front galley zone 126 and/or a rear galley zone 128.

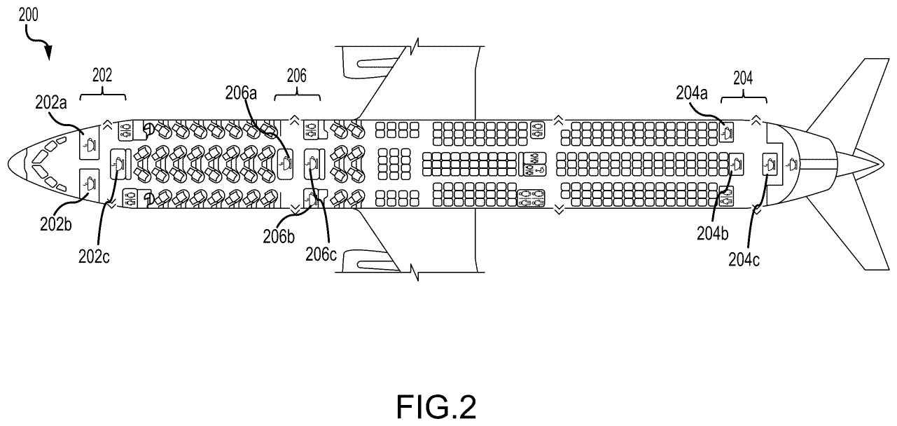

Referring now to FIG. 2, a layout of a typical larger-bodied passenger aircraft, is illustrated, in accordance with various embodiments. In various embodiments, aircraft 200 (such as aircraft 100 of FIG. 1) includes three galley zones, a front galley zone 202 (such as front galley zone 126 of FIG. 1), a rear galley zone 204 (such as rear galley zone 128 of FIG. 1), and intermediate galley zone 206. In various embodiments, each of the front galley zone 202, the rear galley zone 204, and the intermediate galley zone 206 may have one or more galleys, i.e., galley 202a, 202b, and 202c associated with the front galley zone 202, galley 204a, 204b, and 204c associated with the rear galley zone 204, galley 206a, 206b, and 206c associated with the intermediate galley zone 206. In various embodiments, each of the galleys 202a, 202b, 202c, 204a, 204b, 204c, 206a, 206b, and 206c in the aircraft 200 may include one or more digital panels with which interaction may occur. In that regard, in various embodiments, each of the one or more digital panels provide a user interface (UI) for the crew members to interface with a language-enabled intelligence system, so as to perform various operations, i.e., adaptively accesses conversation memory, track inventory states, and/or monitor crew activity, among others, inferred from a streaming multimodal (vision and thermal) video data in real-time to provide automatic predictive crew service triggers and manage interior functions with high assurance.

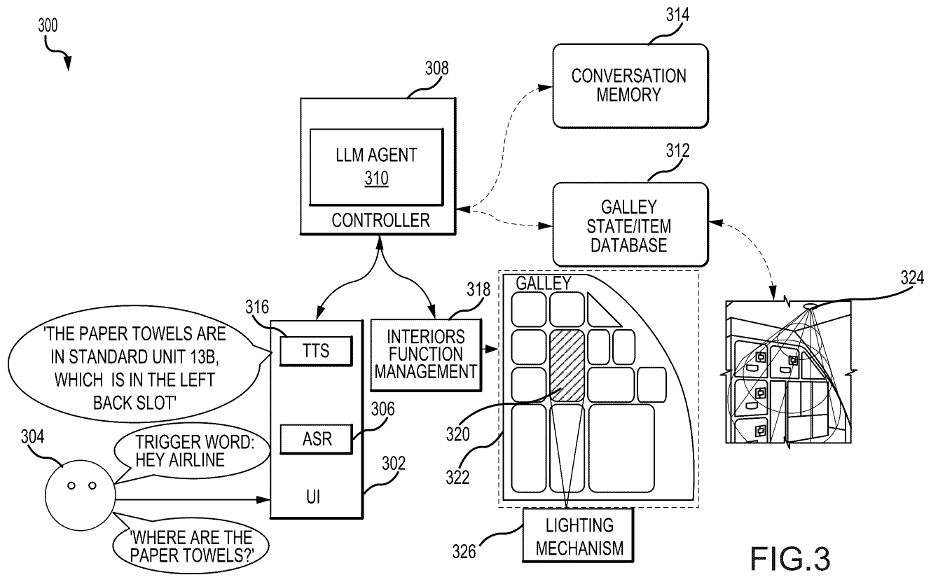

Referring now to FIG. 3, a language-enabled intelligence system is illustrated, in accordance with various embodiments. In various embodiments, the language-enabled intelligence system 300 utilizes a seamless natural language interface based on a domain-grounded and large language model (LLM) intelligence agent configured with an artificial intelligence (AI) model including a machine learning (ML) model, deep learning model, neural network, convolutional neural network, computer vision algorithm, object detection algorithm, object recognition algorithm, classification algorithm, regression algorithm, or other computational model configured to allow crew members and/or passengers to converse with the language-enabled intelligence system 300 in various areas within the interior of the aircraft, such as a galley, i.e., galleys 202a, 202b, 202c, 204a, 204b, 204c, 206a, 206b, and 206c of FIG. 2, or with an infotainment system associated with passenger seat, i.e., passenger seat 130 of FIG. 1, among others. In various embodiments, the language-enabled intelligence system 300, in real time, adaptively accesses conversation memory, inventory states, and/or crew activity inferred from streaming multimodal data in real-time, among others, to provide automatic predictive crew service triggers and manage interior functions with high assurance.

In various embodiments, the language-enabled intelligence system 300 may include a user interface (UI) 302, for example, the infotainment system associated with each passenger seat, such as passenger seat 130 of FIG. 1, or one or more digital panels, such as the one or more digital panels associated with galleys 202a, 202b, 202c, 204a, 204b, 204c, 206a, 206b, and 206c of FIG. 2, among others. In various embodiments, the UI 302 includes an automatic speech recognition (ASR) mechanism 306 configured to interpret words spoken by the crew member and/or passenger 304 and generate a text form of the interpreted words. In various embodiments, the ASR mechanism 306 may employ acoustic models, language models, pronunciation dictionaries, or neural network-based speech recognition techniques including, but not limited to, recurrent neural networks (RNNs), long short-term memory (LSTM) networks, or transformer architectures, to convert audio input into text. In various embodiments, the ASR mechanism 306 is configured to transmit the text form of the interpreted words to a controller 308.

In various embodiments, the controller 308 comprises dedicated input/output interfaces configured to receive information from the UI 302. In various embodiments, the controller 308 may further comprise internal memory to store data, executable instructions, system program instructions, and/or controller instructions to implement the control logic of controller 308. In various embodiments, the memory comprises volatile memory, such as random access memory (RAM) including static RAM (SRAM) or dynamic RAM (DRAM), for storing real-time sensor data, and non-volatile memory, such as flash memory, electrically erasable programmable read-only memory (EEPROM), or solid-state storage, for storing control parameters, calibration data, and operational thresholds. In various embodiments, the controller 308 may comprise one or more processing units including, but not limited to, microprocessors, microcontrollers, digital signal processors (DSPs), field-programmable gate arrays (FPGAs), application-specific integrated circuits (ASICs), graphics processing units (GPUs), tensor processing units (TPUs), or combinations thereof.

System program instructions and/or controller instructions may be loaded onto a non-transitory, tangible computer-readable medium having instructions stored thereon that, in response to execution by the controller 308, cause the controller 308 to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the controller 308 includes an LLM agent 310, which is configured to utilize one or more fusion modules, data integration techniques, or aggregation methods to classify and filter the interpreted words based on at least one of context and intent, i.e., a question or statement, among others, derived from the set of interpreted words as well as additional context, such as current live status of items or interior features from galley state/item database 312 and/or conversation memory 314, among others, as will be described hereafter in detail, to generate an appropriate response to the crew member and/or passenger. In various embodiments, the LLM agent 310 may implement transformer-based architectures, attention mechanisms, encoder-decoder structures, or other neural network configurations suitable for natural language understanding and generation. In various embodiments, the LLM agent 310 is configured to respond to the crew member and/or passenger via a text to speech (TTS) mechanism 316 that generates voice narrations using the data from the generated response in the UI 302 and/or display the information on a display of the UI 302. In various embodiments, the LLM agent 310 may be configured to utilize an interiors function management mechanism 318 to indicate a bin or an insert 320, among others, within galley 322, such as one of galleys 202a, 202b, 202c, 204a, 204b, 204c, 206a, 206b, and 206c of FIG. 2, to be accessed in association with the response issued via a voice command via the TTS mechanism 316 or a lighting mechanism 326 that is configured to illuminate the bin or the insert 320 or activate an indicator associated with the bin or the insert 320.

In various embodiments, the language-enabled intelligence system 300 may be configured to perform personalized conversation with a crew member and/or passenger and assist the crew member and/or passenger by performing some tasks via question decomposition, planning and allocation, in-context knowledge retrieval from the cabin-relevant knowledge base, augmentation to other “trusted” functions in the cabin systems, high level reasoning, and an explanatory helpful response. In various embodiments, inventory states may be updated based on crew verbal feedback, received via the ASR mechanism 306 and processed by the LLM agent 310, in response to video sensors being occluded in an operational environment.

In addition to the above, in various embodiments, the language-enabled intelligence system 300, specifically, the controller 308, may be communicatively coupled to one or more sensors through any suitable communication interface, including wired connections, wireless connections, or hybrid configurations. The one or more sensors may include, without limitation, optical sensors, thermal sensors, infrared sensors, near-infrared sensors, mid-infrared sensors, far-infrared sensors, ultraviolet sensors, ultrasonic sensors, pressure sensors, weight sensors, proximity sensors, capacitive sensors, inductive sensors, piezoelectric sensors, image sensors (including complementary metal-oxide-semiconductor (CMOS), charge-coupled device (CCD), and time-of-flight image sensors), depth sensors, three-dimensional (3D) sensors, light detection and ranging (LIDAR) sensors, radio detection and ranging (RADAR) sensors, multispectral sensors, hyperspectral sensors, radio frequency sensors, electromagnetic sensors, acoustic sensors, vibration sensors, chemical sensors, gas sensors, humidity sensors, temperature sensors, motion sensors, accelerometers, gyroscopes, magnetometers, or any combination thereof, as well as any future-developed sensor technologies capable of detecting, measuring, or capturing environmental conditions, object states, user activities, or physical parameters. The present disclosure contemplates that sensor technology will continue to evolve, and the system is expressly designed to accommodate integration of sensor modalities not yet developed or commercially available at the time of filing. In various embodiments, the communication interface may utilize any suitable protocol including, but not limited to, digital interfaces, analog interfaces, serial communication protocols, parallel communication protocols, I2C, SPI, UART, CAN bus, USB, Ethernet, optical fiber communication, power line communication, or proprietary protocols, as well as any future communication standards developed for avionics or cabin systems. In various embodiments, wireless communications may operate within any frequency bands approved for aircraft cabin use for radio frequency susceptibility and emissions, including but not limited to wireless local area network protocols (e.g., that sold under the Wi-Fi trademark), short-range wireless protocols (e.g., that sold under the Bluetooth trademark), Bluetooth Low Energy, mesh network protocols (e.g., that sold under the Zigbee or Z-Wave trademarks), IEEE 802.15.4, IEEE 802.11 variants, 5G, cellular communication protocols, satellite communication protocols, ultra-wideband (UWB), or other existing or future wireless standards, thereby ensuring no or reduced interference with aircraft avionics, navigation systems, and/or communication equipment.

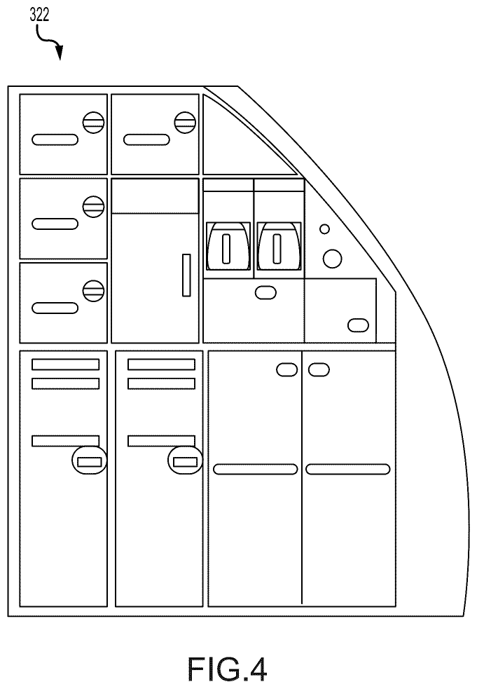

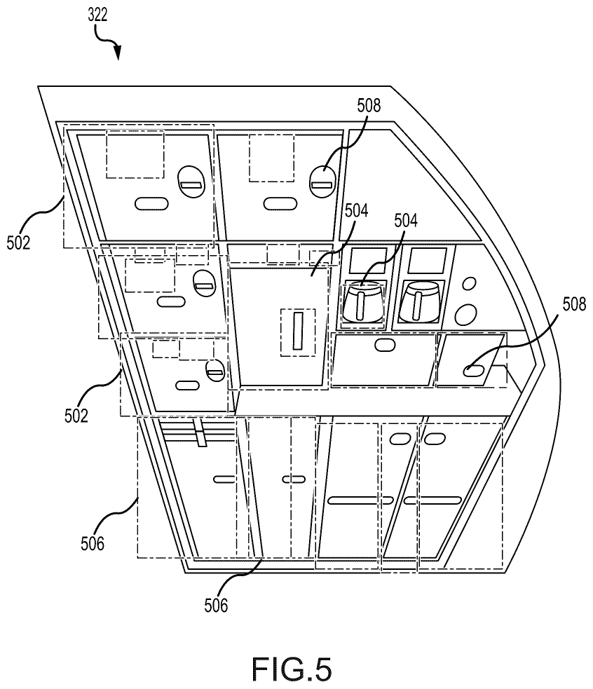

Therefore, in various embodiments, the controller 308 may be coupled to one or more sensing devices, including but not limited to a camera 324 configured to capture multimodal video data, thermal data, or other imaging data, using any suitable detection method including optical character recognition, barcode reading, QR code reading, RFID detection, NFC detection, image recognition, pattern recognition, object detection, scene analysis, thermal signature analysis, infrared thermography, spectral analysis, weight measurement, load cell measurement, acoustic analysis, vibration analysis, electromagnetic field detection, or other existing or future sensing modalities, to recognize and identify the current environment, such as the galley 322 shown in FIG. 4, and allow the crew member and/or passenger to converse about a state of the environment. In various embodiments, the one or more sensing devices may be positioned at any location within, adjacent to, above, below, or in proximity to the galleys or other aircraft interior regions, including without limitation: within standard units; on, in, or behind doors; on ceilings or overhead panels; on or within walls, partitions, or bulkheads; on or beneath countertops; within, on, or adjacent to cabinets, compartments, or storage areas; on, in, or underneath carts; at galley entrances, exits, or transition zones; within or on bins, drawers, or inserts; integrated into lighting fixtures or panels; embedded within structural components; mounted on movable or adjustable brackets; positioned in corners or recessed areas; or at any other location suitable for providing optimal coverage, detection capabilities, and monitoring of galley operations, passenger areas, or crew activities. The sensing devices may be permanently installed, removably mounted, integrated into existing aircraft components, or retrofitted into pre-existing aircraft configurations. With temporary reference to FIG. 5, in accordance with various embodiments, a view from a camera 324 of FIG. 3 is illustrated where the camera is configured to provide a streaming view of the galley 322 and the language-enabled system utilizes the one or more of multimodal video data and or thermal data to identify the various bins 502, inserts 504, or carts 506, among others and their associated labels 508. Returning to FIG. 3, in that regard, the language-enabled intelligence system 300 may be configured to use any suitable data processing techniques, including signal processing, image processing, video processing, pattern recognition, machine learning, deep learning, neural network processing, computer vision, statistical analysis, filtering, transformation, aggregation, sensor fusion, data fusion, or combinations thereof, to detect objects and their states, i.e., open or close for latches or doors on bins and carts, on or off status for inserts (including, in various embodiments, thermal treatment devices such as ovens, beverage preparation devices such as coffee makers, or cooling devices such as chillers, among others), crew presence/absence, or coffee maker stowed or not stowed, among others.

In various embodiments, the language-enabled intelligence system 300 may be configured to utilize state machine logic to perform temporal filtering and persistent tracking of object states/locations and generate state triggers for user interface visualization, e.g., a latch associated with a first bin is open or items in second bin are moved to a third bin, among others. In various embodiments, the language-enabled intelligence system 300 may be configured to identify and communicate operation instructions to a crew member via the UI 302 to prepare the galley for taxi, take-off, and/or landing (TTOL), such as close the open cart door or close latch on bin. In various embodiments, the language-enabled intelligence system 300 may be configured to perform automatic control actions: such as turning on or off lights in galley in response to crew member presence being detected, or, in various embodiments, turning on or off a cooling device (such as a chiller) or a heating device (such as a heater) in response to a change in flight status, among others.

In various embodiments, the language-enabled intelligence system 300 may be configured to track inventory items, such as locating consumable goods (including, in various embodiments, beverage containers such as cups, sanitary products such as paper towels, or provisions such as food items), among others, and reporting their location with voice via the TTS mechanism 316, the display of UI 302, and/or a light via lighting mechanism 326 or an indicator associated with the bin or the insert 320. In various embodiments, the language-enabled intelligence system 300 may be configured to perform order management, i.e., storing the passenger orders in conversation memory 314 for recall to crew members via the TTS mechanism 316 or the display of UI 302. In various embodiments, the language-enabled intelligence system 300 may be configured to detect bin labels via the camera 324 in order to keep track of bin contents and store the item information in galley state/item database 312. In various embodiments, the language-enabled intelligence system 300 may be configured to track bin location, i.e., identifying inventory that has been moved from one bin to another bin, and store/access the inventory information in galley state/item database 312, which may be reported back to the crew member via the TTS mechanism 316 or the display of UI 302 in response to a request being received via the UI 302 and/or the ASR mechanism 306.

In various embodiments, the language-enabled intelligence system 300 may be configured to monitor counter area(s), i.e., detect debris or liquid spills, among others. In various embodiments, the language-enabled intelligence system 300 may be configured to detect temperature anomalies for proper operation of insert equipment, e.g., cooling devices (such as chillers), heating devices (such as heaters), or beverage preparation devices (such as coffee makers), among others. In various embodiments, the language-enabled intelligence system 300 may be configured to detect damage to a galley or other interior location, e.g., galley wear/tear; damaged bins, latches, or doors, torn seats, or damaged infotainment systems, among others. In various embodiments, the language-enabled intelligence system 300 may be configured to fuse an object with state info from different cameras 324 based on probability of detection. In that regard, in various embodiments, the language-enabled intelligence system 300 may then feed the instantaneous inferred state into a state machine mechanism and utilize a business decision mechanism to generate appropriate crew member service triggers via the TTS mechanism 316 or the display of UI 302 and dispatch automatic control actions for galley functions. In such cases, in various embodiments, the language-enabled intelligence system 300 may be configured to log equipment health, e.g., anomalous heating/cooling for chiller/oven and galley damage, for offboard analysis to facilitate maintenance and further extensions for conversations.

Accordingly, the language-enabled system is configured to reduce crew member workload and increase efficiency by predictive reporting of a state of interior of the aircraft by, for example, providing inventory tracking, e.g., which item is in which bin, safety checks, bins and/or carts latched during TTOL. Additionally, the language-enabled system is configured to provide actionable data, such as galley or seat damage. Further, the language-enabled system is configured to detect insert issues, e.g., detect empty chiller units and put them into a power saving mode or door open checks to alert crew of thermal leakage, among others.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A language-enabled intelligence system for aircraft interiors, comprising:
a user interface configured to receive and transmit information to a user, the user interface comprising:
an automatic speech recognition (ASR) mechanism configured to interpret the information received via the user interface and generate a set of interpreted words in text form; and
a text to speech (TTS) mechanism configured to create voice narrations from text provided to the TTS mechanism; and
a controller configured to:
classify and filter the set of interpreted words based on at least one of context or intent derived from the set of interpreted words; and
generate a response, wherein the response is the text that is transmitted to the user interface and relayed to the user via the TTS mechanism.

2. The language-enabled intelligence system of claim 1, wherein the controller is configured to further utilize a status of at least one of items or interior features from a galley to generate the response.

3. The language-enabled intelligence system of claim 2, wherein the status of the at least one of the items or the interior features from the galley is stored in a galley state/item database.

4. The language-enabled intelligence system of claim 3, wherein the controller is further configured to update the status of the at least one of the items or the interior features using temporal filtering and persistent tracking.

5. The language-enabled intelligence system of claim 4, wherein the temporal filtering and persistent tracking is performed using data from at least one sensor, wherein the at least one sensor comprises at least one of an optical sensor, a thermal sensor, an infrared sensor, a near-infrared sensor, a mid-infrared sensor, a far-infrared sensor, an ultraviolet sensor, an ultrasonic sensor, a pressure sensor, a weight sensor, a proximity sensor, a capacitive sensor, an inductive sensor, a piezoelectric sensor, an image sensor, a time-of-flight sensor, a depth sensor, a three-dimensional (3D) sensor, a light detection and ranging (LIDAR) sensor, a radio detection and ranging (RADAR) sensor, a multispectral sensor, a hyperspectral sensor, a radio frequency sensor, an electromagnetic sensor, an acoustic sensor, a vibration sensor, a chemical sensor, a gas sensor, a humidity sensor, a temperature sensor, a motion sensor, an accelerometer, a gyroscope, a magnetometer, an RFID sensor, an NFC sensor, or any combination thereof.

6. The language-enabled intelligence system of claim 3, wherein the controller is further configured to update the status of the at least one of the items or the interior features using verbal feedback received via the ASR mechanism and processed via the controller.

7. The language-enabled intelligence system of claim 1, wherein the controller is further configured to communicate instructions to a crew member, via the user interface, to prepare a galley for taxi, take-off, and/or landing (TTOL).

8. The language-enabled intelligence system of claim 1, wherein the controller is further configured to, responsive to generating the response via the user interface, illuminate at least one of a bin or an insert in a galley or activate an indicator associated with the bin or the insert.

9. The language-enabled intelligence system of claim 1, wherein the user interface is at least one of an infotainment system associated with a passenger seat of the aircraft or a digital panel associated with a galley on the aircraft.

10. The language-enabled intelligence system of claim 9, wherein the response transmitted to the user interface is displayed to the user via the at least one of the infotainment system associated with the passenger seat of the aircraft or the digital panel located in the galley on the aircraft.

11. An aircraft comprising:
a passenger seat;
an infotainment system associated with the passenger seat;
a galley;
a digital panel associated with the galley; and
a language-enabled intelligence system coupled to at least one infotainment system or the digital panel, the language-enabled intelligence system comprising:
a user interface configured to receive and transmit information to a user, the user interface comprising:
an automatic speech recognition (ASR) mechanism configured to interpret the information received via the user interface and generate a set of interpreted words in text form; and
a text to speech (TTS) mechanism configured to create voice narrations from text provided to the TTS mechanism; and
a controller configured to:
classify and filter the set of interpreted words based on at least one of context or intent derived from the set of interpreted words; and
generate a response, wherein the response is the text that is transmitted to the user interface and relayed to the user via the TTS mechanism.

12. The aircraft of claim 11, wherein the controller is configured to further utilize a status of at least one of items or interior features from a galley to generate the response.

13. The aircraft of claim 12, wherein the status of the at least one of the items or the interior features from the galley is stored in a galley state/item database.

14. The aircraft of claim 13, wherein the controller is further configured to update the status of the at least one of the items or the interior features using temporal filtering and persistent tracking.

15. The aircraft of claim 14, wherein the temporal filtering and persistent tracking is performed using data from at least one sensor, wherein the at least one sensor comprises at least one of an optical sensor, a thermal sensor, an infrared sensor, a near-infrared sensor, a mid-infrared sensor, a far-infrared sensor, an ultraviolet sensor, an ultrasonic sensor, a pressure sensor, a weight sensor, a proximity sensor, a capacitive sensor, an inductive sensor, a piezoelectric sensor, an image sensor, a time-of-flight sensor, a depth sensor, a three-dimensional (3D) sensor, a light detection and ranging (LIDAR) sensor, a radio detection and ranging (RADAR) sensor, a multispectral sensor, a hyperspectral sensor, a radio frequency sensor, an electromagnetic sensor, an acoustic sensor, a vibration sensor, a chemical sensor, a gas sensor, a humidity sensor, a temperature sensor, a motion sensor, an accelerometer, a gyroscope, a magnetometer, an RFID sensor, an NFC sensor, or any combination thereof, or any subsequently developed sensor technology capable of detecting environmental conditions, object states, or physical parameters.

16. The aircraft of claim 13, wherein the controller is further configured to update the status of the at least one of the items or the interior features using verbal feedback received via the ASR mechanism and processed via the controller.

17. The aircraft of claim 11, wherein the controller is further configured to communicate instructions to a crew member, via the user interface, to prepare a galley for taxi, take-off, and/or landing (TTOL).

18. The aircraft of claim 11, wherein the controller is further configured to, responsive to generating the response via the user interface, illuminate at least one of a bin or an insert in a galley or activate an indicator associated with the bin or the insert.

19. The aircraft of claim 11, wherein the response transmitted to the user interface is displayed to the user via the infotainment system associated with the passenger seat of the aircraft.

20. The aircraft of claim 19, wherein the response transmitted to the user interface is displayed to the user via the digital panel located in the galley on the aircraft.
